(19) United States
(12) Patent Application Publication
(10) Pub. No.: US 2021/0246781 A1
(43) Pub. Date: Aug. 12, 2021

(54) BARRIER MANAGEMENT SYSTEM

(71) Applicant: Ensco International Incorporated, Wilmington, DE (US)

(72) Inventors: Robin Russell Kimber, Aberdeen (GB); Michael John Lawson, Houston, TX (US); Kerri Lynn Maurina, Houston, TX (US); Vincent Rivera, Houston, TX (US)

(21) Appl. No.: 16/784,984

(22) Filed: Feb. 7, 2020

(51) Int. Cl. E21B 47/12; E21B 47/06; E21B 47/00; E21B 44/00; G06F 3/0482

(52) U.S. Cl. CPC E21B 47/12; E21B 47/06; G06F 3/0482; E21B 44/00; E21B 47/0001

(57) ABSTRACT

A system, includes a computing system having an interface configured to receive a first signal indicative of operational data of a device engaged in hydrocarbon and/or emergency response operations. The computing system further includes a memory configured to store a value corresponding to non-operational data related to a crewmember interaction with the device and/or operational data from technical/plant barrier elements. The computing system additionally includes a processor configured to generate a graphical user interface, wherein the graphical user interface comprises a status identifier generated based upon the first signal and the value.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Advances and technologies deployed in the petroleum industry have allowed access to oil and gas drilling locations and reservoirs that were previously inaccessible due to technological limitations. For example, technological advances have allowed drilling of offshore wells at increasing water depths and in increasingly harsh environments, permitting oil and gas resource owners to successfully drill for otherwise inaccessible energy resources. As access to energy resources continues to develop, there is an increased need for implementation and monitoring of barriers, i.e., measures intended to identify, mitigate, and/or otherwise prevent conditions that may lead to failures, hazards, accidents, or the like that would otherwise prevent and/or hinder the extraction of these energy resources.

### BRIEF DESCRIPTION OF DRAWINGS

FIG. 1 illustrates an example of an offshore platform having a riser coupled to a blowout preventer (BOP), in accordance with an embodiment;

FIG. 2 illustrates a barrier implemented in conjunction with hydrocarbon operations undertaken by the offshore platform of FIG. 1;

FIG. 3 illustrates a barrier element of FIG. 2, in accordance with an embodiment;

FIG. 4 illustrates a block diagram of a computing system of the offshore platform of FIG. 1, in accordance with an embodiment;

FIG. 5 illustrates a graphical user interface of the computing system of FIG. 4, in accordance with an embodiment;

FIG. 6 illustrates a screen shot of an example of a composition page as a portion of a barrier management system tool of the computing system of FIG. 4, in accordance with an embodiment;

FIG. 7 illustrates a screen shot of an example of a sub-screen of the composition page of FIG. 6, in accordance with an embodiment; and

FIG. 8 illustrates a screen shot of an image 114 of the offshore platform of FIG. 1, in accordance with an embodiment.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

Oil and gas drilling operations continue to expand in complexity. For example, technological innovations have brought about the incorporation of technological tools (e.g. cyber-based chairs showing real-time data, offshore servers with ability to replicate data, etc.) used in offshore operations. Along with these advances, activities and situations that potentially prevent the proper functioning of oil and gas operations continue to grow. These impediments to operations can be minimized through the use of barriers, i.e., prevention measures intended to identify, mitigate, and/or otherwise prevent conditions that may lead to failures, hazards, accidents, or the like that would otherwise prevent and/or hinder the extraction of these energy resources. Additionally, barriers can include responses, including emergency responses, to hazardous events as well as status of the responses to an incident. These barriers may include operational and/or safety systems, processes, and/or techniques utilized to facilitate continued hydrocarbon operations. For example, if undesirable situations and/or conditions are not prevented, controlled, detected, and/or mitigated by barriers, for example, events, such as a stoppage of the hydrocarbon operations, may occur.

As the introduction of additional barriers in hydrocarbon operations increase, it becomes more important to insure that these barriers are properly functioning and available, so that they will be able to successfully minimize and/or prevent adverse situations. Thus, the use of a management system for monitoring and/or controlling the implemented barriers becomes increasingly desirable for successful hydrocarbon operations. Both operational and non-operational (e.g., user based) elements may be combined to form a particular barrier (e.g., a barrier system inclusive of barrier elements). Accordingly, to insure the success of implemented barriers, both operational and non-operational elements of the implemented barriers should be monitored and/or controlled to allow for the continued functioning of hydrocarbon operations. Accordingly, a system is provided herein that operates to provide a barrier system that operates by utilizing both operational information and user information to allow for better predictions of the functionality of barriers used in promoting successful oil and gas (hydrocarbon) operations. The system described herein can operate as a monitoring and/or a control system used in conjunction with implemented barriers. By aggregating both operational and non-operational inputs into a barrier management system, the overall health of underlying barrier systems and/or their particular barrier elements can be improved. Additionally, through the use of both operational and non-operational inputs, an improved computer and/or control system is achieved, as previous systems for operational impediments fail to adequately account for the different types of causes of system failures and/or potential failures (e.g., technical/plant barrier elements, operating/process barrier elements, and organizational/people barrier elements). Furthermore, the present system can include weighting of the various inputs used to determine barrier health and system compliance (i.e., whether impediments or other barriers are present that would cause a device or a system failure and/or a potential failure). Additionally, system compliance can be preset with configurations that match jurisdictional and/or customer requirements.

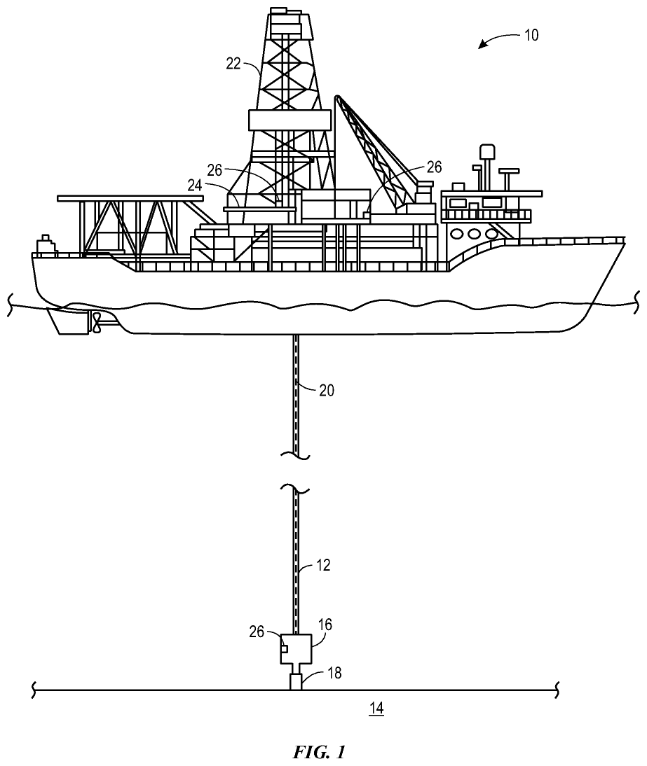

With the foregoing in mind, FIG. 1 illustrates an offshore platform 10 as a drillship. Although the presently illustrated embodiment of an offshore platform 10 is a drillship (e.g., a ship equipped with a drilling system and engaged in offshore oil and gas exploration and/or well maintenance or completion work including, but not limited to, casing and tubing installation, subsea tree installations, and well capping), other offshore platforms 10 that engage in oil and gas operations, for example, a semi-submersible platform, a spar platform, a floating production system, or the like may be substituted for the drillship. Alternatively, a self-elevating unit, such as a jackup rig may be used as the offshore platform 10. Thus, while the techniques and systems described below are described in conjunction with a drillship, the techniques and systems are intended to cover at least the additional offshore platforms 10 described above. Likewise, while an offshore platform 10 is illustrated and described in FIG. 1, the techniques and systems described herein may also be applied to and utilized in onshore drilling activities. These techniques may also apply to at least vertical drilling or production operations (e.g., having a rig in a primarily vertical orientation drill or produce from a substantially vertical well) and/or directional (e.g., horizontal) drilling or production operations (e.g., having a rig in a primarily vertical orientation drill or produce from a substantially non-vertical or slanted well or having the rig oriented at an angle from a vertical alignment to respective to drill or produce from a substantially non-vertical or slanted well).

As illustrated in FIG. 1, the offshore platform 10 includes a riser string 12 extending therefrom. The riser string 12 may include a pipe or a series of pipes that connect the offshore platform 10 to the seafloor 14 via, for example, a BOP 16 that is coupled to a wellhead 18 on the seafloor 14. In some embodiments, the riser string 12 may transport produced hydrocarbons and/or production materials between the offshore platform 10 and the wellhead 18, while the BOP 16 may include at least one BOP stack having at least one valve with a sealing element to control wellbore fluid flows. In some embodiments, the riser string 12 may pass through an opening (e.g., a moonpool) in the offshore platform 10 and may be coupled to drilling equipment of the offshore platform 10. As illustrated in FIG. 1, it may be desirable to have the riser string 12 positioned in a vertical orientation between the wellhead 18 and the offshore platform 10 to allow a drill string made up of drill pipes 20 to pass from the offshore platform 10 through the BOP 16 and the wellhead 18 and into a wellbore below the wellhead 18. Also illustrated in FIG. 1 is a drilling rig 22 (e.g., a drilling package or the like) that may be utilized in the drilling and/or servicing of a wellbore below the wellhead 18.

Additionally present on the offshore platform 10 is a control room (e.g., a driller's cabin) that may be disposed on or adjacent to a drill floor 24. The control room may be an area of the offshore platform 10 that consolidates, for example, safety systems, drilling controls, automated pipe handling controls, and/or computer hardware and data processing systems used into single location. Additionally, illustrated in FIG. 1 is a series of sensors 26. These sensors 26 may include, but are not limited to non-contact sensors (e.g., ultrasonic sensors, microwave sensors), capacitance sensors, and float sensors, among others. Additionally or alternatively, the sensors 26 can include optical sensors, flow sensors, among others. The sensors 26 can be disposed on various operational components on the offshore platform 10, for example, a tripping apparatus, a roughneck, a mud monitoring system, etc. Likewise, the sensors 26 may be disposed on or in the BOP 16, within a formation below the wellbore 18 (e.g., as part of a bottom hole assembly), etc. The sensors 26 may operate to measure the operating characteristics of the various devices and systems used in hydrocarbon operations. These operational characteristics measured by the sensors 26 may include the current status of the devices or systems (i.e., current operating conditions) as well as lifespan characteristics (i.e., degradation or wear of components of the device or system over a predetermined period of time). The lifespan characteristics measured by the sensors 26 may correspond to maintenance and/or replacement schedules for components of the devices or systems being monitored.

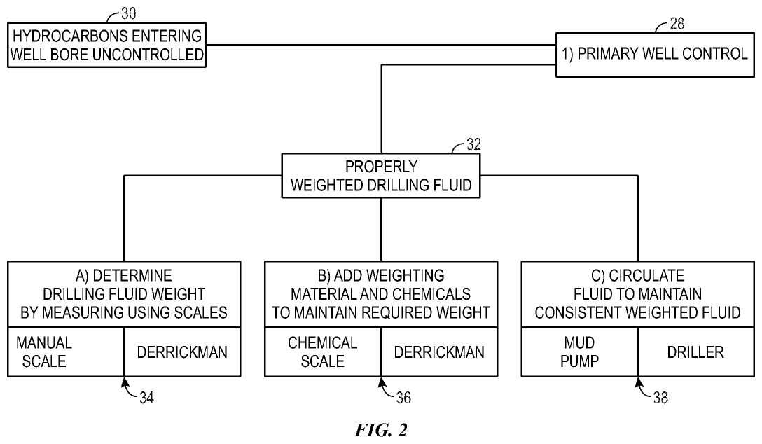

FIG. 2 illustrates an example of a barrier 28 implemented in conjunction with hydrocarbon operations undertaken by the offshore platform 10. The barrier 28, as illustrated, represents primary well control that may operate to prevent or minimize an event 30, here the presence of hydrocarbons entering a wellbore below the wellhead 18. Barrier 28, as illustrated, generally operates to maintain a hydrostatic pressure provided by drilling fluid (i.e., mud) that is greater than the pressure exerted by the fluids in a formation and less a pressure required to induce fractures in formation at a given depth (i.e., the fracture gradient). Barrier 28 may be made up of or otherwise include sub-barriers, such as sub-barrier 32, which itself includes one or more barrier elements, such as barrier elements 34, 36, and 38. Sub-barrier 32 may represent providing properly weighted drilling fluid and sub-barrier 32, more generally, represents a sub-function that allows for the operation of the barrier 28. While one sub-barrier 32 is illustrated, it should be appreciated that zero, one, or more sub-barriers may be utilized to successfully implement a particular barrier. Moreover, while only barrier 28 and event 30 are illustrated, it should be appreciated that additional barriers each directed to preventing and/or minimizing a respective event are contemplated.

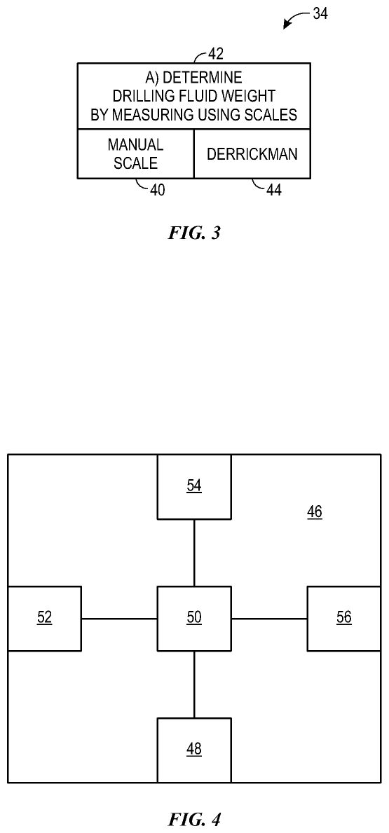

Barrier elements 34, 36, and 38 each represent one function or aspect to successfully implement sub-barrier 32. For example, barrier element 34 represents determining drilling fluid weight by measuring scales (e.g., scales as one of sensors 26). Barrier element 36 represents an addition of weighting material and chemicals to maintain a required weight of the drilling fluid and barrier element 38 (which may be determined, for example, by sensed values by a sensor 26) represents circulating the fluid to maintain consistent weighted fluid (e.g., whereby the circulation may be measured by a sensor 26). In this manner, each of barrier elements 34, 36, and 38 are particular operations that in combination allow for the sub-barrier 32 to properly function. More generally, barrier elements represent a sub-function that allow for the operation of a sub-barrier and/or operation of a barrier. Indeed, one or more barrier elements may be utilized in place of or in conjunction with one or more sub-barriers to successfully implement a particular barrier. The portions of a barrier element are discussed below in conjunction with FIG. 3.

FIG. 3 illustrates an example of a barrier element, specifically barrier element 34. As illustrated, barrier element 34 includes a technical barrier element 40, an operating barrier element 42, and an organizational barrier element 44. The technical barrier element 40 and the operating barrier element 42 are both operational elements (i.e., elements determined based upon one or more characteristics regarding the physically status of a particular device or system utilized in a hydrocarbon process separate from or independent of the operation of the device or system). For example, technical barrier element 40 represents at least one physical characteristic of a manual scale (e.g., a physical characteristic of the manual scale or a component thereof independent from its current operation). These characteristics may include maintenance information (e.g., is the manual scale up to date with its maintenance and/or how close is the manual scale or a component thereof to being scheduled for maintenance), part life information (e.g., is the manual scale or a component thereof approaching its recommended part life to be replaced and/or has the manual scale or a component thereof met or exceeded its expected part life to be replaced), configuration information (e.g., has the manual scale or a component thereof been set up correctly to properly function), or the like. One or more of the sensors 26 may advantageously be utilized to sense physical characteristics of the manual scale or a component thereof independent from its current operation conditions to insure the proper functioning of barrier element 34. The one or more of the sensors 26 may detect (either directly or via sensing a condition affecting one or more of the devices and/or systems employed in conjunction with the barrier element 34) the above described physical characteristics of technical barrier element 40. Thus, the operational data or inputs for the technical barrier element 40 can, for example, include computer maintenance management system (e.g., device or system management instructions) inclusive of corrective work orders, preventative work orders, and/or performance stand tests, they can include sensor data from sensors 26 as well as equipment status, which may also be measured via sensors 26.

Operational barrier element 42 outlines a process for acting on a given technical barrier element 40 (i.e., the process for activating a technical barrier element 40). The respective technical barrier elements 40 may represent at least one runtime characteristic of an operation, for example, to determine a drilling fluid weight by measuring using a scale (e.g., a characteristic of the manual scale or a component thereof or associated machinery that is measured based upon its current operation). These characteristics may include an operating threshold of the manual scale or a component thereof, an output of the manual scale or a component thereof, or other physical characteristics that are measured in real time, in near real time, or are measured and stored for later analysis. The measurements are indicative of the health (i.e., proper functioning) of the manual scale or a component thereof or another component used in the operation to determine a drilling fluid weight by measuring using a scale. One or more of the sensors 26 may advantageously be utilized to sense the runtime characteristics of the manual scale or a component thereof independent from its current operation conditions to insure the proper functioning of barrier element 34. The one or more of the sensors 26 may detect (either directly or via sensing a condition affecting one or more of the devices and/or systems employed in conjunction with the barrier element 34) the above described physical characteristics of a technical barrier element 40. Thus, the operational data or inputs for the operational barrier element 42 can, for example, include a work instruction management system (e.g., operating instructions), sensor data from sensors 26, as well as safe system of work data, which may also be measured via sensors 26.

Additionally, barrier element 34 includes a non-operational element (e.g., a user based element that reflects one or more aspects of the user involved with the execution of barrier element 34). As illustrated, the non-operational element is organizational barrier element 44. Organizational barrier 44 represents a derrickman and can include, for example, test and assessment information (e.g., whether the derrickman has taken and/or successfully passed a test or drill simulating a failure condition of the manual scale or another component used in the operation to determine a drilling fluid weight by measuring using a scale), compliance information (e.g., whether the derrickman has received the proper training or is certified to operate the manual scale or another component used in the operation to determine a drilling fluid weight by measuring using a scale), observed compliance or on-the-job training (e.g., whether the derrickman has been observed successfully operating the manual scale or another component used in the operation to determine a drilling fluid weight by measuring using a scale), or the like. Non-operational data or inputs can, for example, include competence management (e.g., the ability of a particular user to demonstrate performance of a particular task when observed), training management (e.g., whether a particular user has the training and/or credentials to perform a certain task), and work party experience (e.g., the ability of a particular user to demonstrate performance of a particular task in a given situation, such as a drill or a test). Thus, the operational data or inputs for the technical barrier element can, for example, include a work instruction management system (e.g., operating instructions) inclusive of corrective work orders, preventative work orders, and/or performance stand tests, sensor data from sensors 26, as well as equipment status, which may also be measured via sensors 26.

In this manner, by including both operational and non-operational elements (e.g., organizational elements or people barrier elements that can include job positions that conduct a job or task on equipment or a plant), barrier element 34 represents a measure of whether both a device and/or a system as well as a crew or crewmember is in compliance to allow for the proper functioning of barrier element 34. Furthermore, barrier elements 36 and 38 also include both operational and non-operational elements such that the proper operation of sub-barrier 32 as well as barrier 28 relies upon both operational and non-operational elements. In some embodiments, a system may be introduced as a monitoring or a monitoring and control system to ensure that the respective devices, systems, and respective crewmembers are in compliance for particular hydrocarbon operation. FIG. 4 illustrates an embodiment of such a computing system that functions to implement the monitoring or monitoring and control system.

FIG. 4 illustrates a computing system 46 that may be present and may operate in conjunction with the barrier 28, the sub-barrier 32, as well as barrier elements 34, 36, and 38. Additional barriers, sub-barriers, and barrier elements may also be managed (i.e., monitored and/or controlled or caused to controlled) via the computing system 46. It should be noted that the computing system 46 may be a standalone unit (e.g., a control monitor). However, in some embodiments, the computing system 46 may be communicatively coupled to a separate main control system, for example, a control system in a control room (e.g., a driller's cabin) that may provide a centralized control system for drilling controls, automated pipe handling controls, and the like. In other embodiments, the computing system 46 may be a portion of the main control system (e.g., a control system or a portion thereof present in the driller's cabin, such as a BOP panel/controls).

An example of the computing system 46 is illustrated in FIG. 4. The computing system 46 may operate in conjunction with software systems implemented as computer executable instructions stored in a (tangible) non-transitory machine readable medium 48 of computing system 46, such as memory, a hard disk drive, or other short term and/or long term storage. Particularly, the techniques to described below with respect to tripping operations may be accomplished, for example, using code or instructions stored in the non-transitory machine readable medium 48 of computing system 46 (such as memory) and may be executed, for example, by a processing device 50 or a controller of computing system 46 to control one or more devices or systems previously described in conjunction with FIGS. 1, 2, and 3.

The computing system 46 may be a general purpose or a special purpose computer that includes a processing device 50, such as one or more application specific integrated circuits (ASICs), one or more processors, or another processing device that interacts with one or more tangible, non-transitory machine-readable medium 48 (e.g., machine readable media) of the computing system 46 that collectively stores instructions executable by the processing device 50 to perform the methods and actions described herein. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by the processing device 50. In some embodiment, the instructions executable by the processing device 50 are used to generate, for example, control signals or input signals to effect control of one or more of the devices of the offshore platform 10, the BOP 16, and/or additional components utilized in a particular hydrocarbon operation.

The computing system 46 may also include one or more input structures 52 (e.g., one or more of a keypad, mouse, touchpad, touchscreen, one or more switches, buttons, or the like) to allow a user to interact with the computing system 46, for example, to start, control, or operate a graphical user interface (GUI) or applications running on the computing system 46 and/or to start, control, or operate, for example, components utilized in a particular hydrocarbon operation. Additionally, the computing system 46 may include a display 54 that may be a liquid crystal display (LCD) or another type of display that allows users to view images generated by the computing system 46. The display 54 may include a touch screen, which may allow users to interact with the GUI of the computing system 46. Likewise, the computing system 46 may additionally and/or alternatively transmit images to a display of a main control system, which itself may also include a non-transitory machine readable medium 48, such as memory, a processing device 50, one or more input structures 52, a display 54, and/or a network interface 56.

As may be appreciated, the above referenced GUI may be a type of user interface that allows a user to interact with the computing system 46 and/or the computing system 46 and one or more sensors (e.g., the control system) through, for example, graphical icons, visual indicators, and the like. Additionally, the computing system 46 may include network interface 56 to allow the computing system 46 to interface with various other devices (e.g., electronic devices). The network interface 56 may include one or more of a Bluetooth interface, a local area network (LAN) or wireless local area network (WLAN) interface, an Ethernet or Ethernet based interface (e.g., a Modbus TCP, EtherCAT, and/or ProfiNET interface), a field bus communication interface (e.g., Profibus), a/or other industrial protocol interfaces that may be coupled to a wireless network, a wired network, or a combination thereof that may use, for example, a multi-drop and/or a star topology with each network spur being multi-dropped to a reduced number of nodes.

In some embodiments, one or more of the components for use in conjunction with a particular hydrocarbon operation may each be a device that can be coupled to the network interface 56. In some embodiments, the network formed via the interconnection of one or more of the aforementioned devices should operate to provide sufficient bandwidth as well as low enough latency to exchange all required data within time periods consistent with any dynamic response requirements of all control sequences and closed-loop control functions of the network and/or associated devices therein. It may also be advantageous for the network to allow for sequence response times and closed-loop performances to be ascertained, the network components should allow for use in oilfield/drillship environments (e.g., should allow for rugged physical and electrical characteristics consistent with their respective environment of operation inclusive of but not limited to withstanding electrostatic discharge (ESD) events and other threats as well as meeting any electromagnetic compatibility (EMC) requirements for the respective environment in which the network components are disposed). The network utilized may also provide adequate data protection and/or data redundancy to ensure operation of the network is not compromised, for example, by data corruption (e.g., through the use of error detection and correction or error control techniques to obviate or reduce errors in transmitted network signals and/or data).

Barrier 28 may be one barrier in barrier management system that operates to ensure proper functioning of one or more hydrocarbon operations. However, as the types of hydrocarbon operations expand and as their complexities increase, a corresponding increase in the number of barriers, in addition to barrier 28, will be present to mitigate, and/or otherwise prevent conditions that may lead to failures, hazards, accidents, or the like that would prevent and/or hinder the extraction of these energy resources. Additionally, as the number of barriers in a barrier management system increase, the importance of managing the barrier management system increases. Accordingly, in some embodiments, a barrier management system may be implemented in the offshore platform 10. More particularly, an improved computer, as computing system 46, may be utilized to implement the barrier management system. In addition, in some embodiments, as part of this barrier management system, a GUI may be generated in conjunction with the computing system 46 for display on the display 54 (or another display, for example, in the control room of the offshore platform 10 or in other locations, such as in a remote onshore or offshore monitoring location).

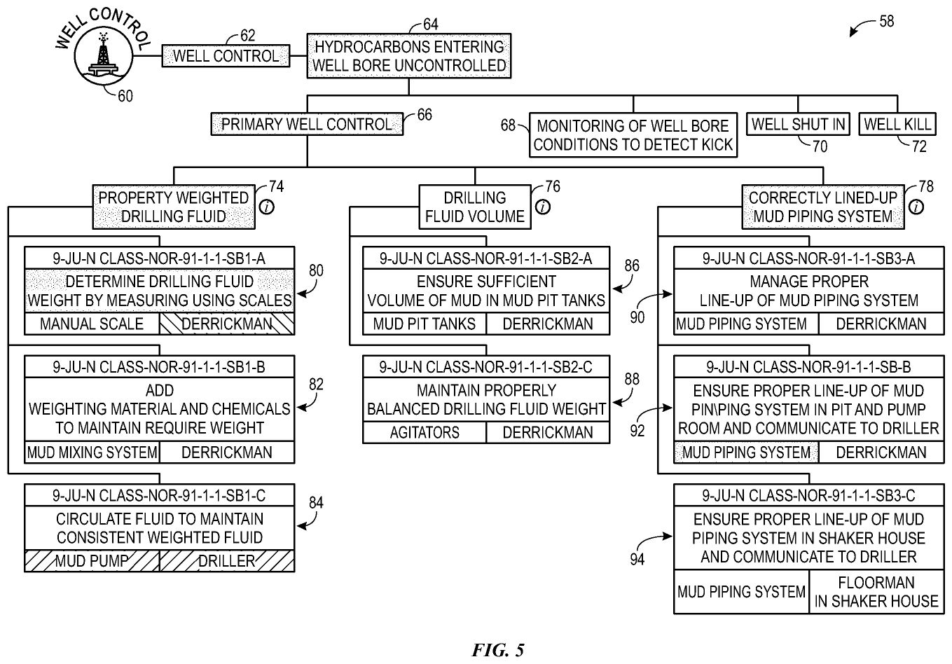

FIG. 5 illustrates an example of a GUI 58 used in conjunction with present embodiments of a barrier management system. As illustrated, the illustrated GUI 58 corresponds to a portion of the barrier management system that operates as a well control, as illustrated by icon 60. In conjunction with icon 60, a status indicator 62 of the health of the well control operation is illustrated. The status indicator 62 may represent whether conditions are currently acceptable for the operation of portion of the barrier management system. The status indicator 62, which may include text, color, or another indicator to provide positive or negative feedback as to the operation of the barriers, sub-barriers and/or barrier events associated with well control illustrated by icon 60.

The GUI 58 is presented in a tree format, whereby the status of the higher elements (moving upwards to and including icon 60) illustrate the health and/or status of the elements in branches beneath the respective icons (e.g., status indicator 66 which represents or may be a barrier, status indicator 74 which represents or may be a sub-barrier, status indicator 80 which represents or may be a barrier system, etc.) Thus, for example, an event icon 64, here the presence of hydrocarbons entering a wellbore below the wellhead 18 in conjunction with event 30, indicates that one or more of the elements associated with the indicators below the event icon has failed and/or is not in compliance. This causes a visual indication (e.g., color change from green representing healthy to yellow or orange representing warning levels in degree of severity or to red representing a failure). The visual indication can include offline barrier elements or data not being properly sourced (e.g. a color such as blue or grey represents no available data due to system issues or equipment is offline or in by-pass mode). Other indications, such as text or alarms can accompany or replace the color changes to indicate to a user an issue with the particular barrier being monitored and displayed.

A level of status indicators 66, 68, 70, and 72 are disposed below the event icon 64 and the corresponding status indicator 62. The status indicator 66 corresponds to barrier 28, while status indicator 68 represents a barrier of monitoring of well bore conditions (via sensors 26) to detect kicks. Status indicator 70 represents a barrier of a well shut in while status indicator 72 represents a well kick. Each of status indicators 68, 70, and 72 may include text, color, or another indicator to provide positive or negative feedback as to the operation of the associated sub-barriers and/or the elements that are part of the respective barrier. Likewise, status indicator 66 includes text, color, or another indicator to provide positive or negative feedback as to the operation of the associated sub-barriers that correspond to status indicators 74, 76, and 78 and/or any elements that are additionally part of barrier 28.

Status indicator 74 corresponds to sub-barrier 32, while status indicator 76 represents a sub-barrier of drilling fluid volume and status indicator 78 represents a sub-barrier of a correctly lined up mud piping system. Each of status indicators 74, 76, and 78 includes text, color, or another indicator to provide positive or negative feedback as to the operation of the associated sub-barriers that correspond to status indicators 74, 76, and 78 and/or any elements that are additionally part of the sub-barriers 74, 76, and 78.

FIG. 5 additionally illustrates status indicators 80, 82, 84, 86, 88, 90, 92, and 94. Status indicators 80, 82, and 84 correspond to the barrier elements 34, 36, and 38, respectively. Likewise, status indicator 86 represents a barrier element of ensuring sufficient volume of mud in mud pit tanks, status indicator 88 represents a barrier element of maintaining properly balanced drilling fluid weight, status indicator 90 represents a barrier element of managing a proper line-up of mud piping system, status indicator 92 represents a barrier element of ensuring a proper line-up of mud piping system in the pit and pump room and communicating to the driller, and status indicator 94 represents a barrier element of ensuring a proper line-up of mud piping system in the shaker house and communicating to the driller. Each of status indicators 80, 82, 84, 86, 88, 90, 92, and 94 may include text, color, or another indicator to provide positive or negative feedback as to the operation of their underlying barrier elements. Moreover, the indicators include operational and non-operational components, as discussed above with respect to FIG. 3.

Status indicators 62, 66, 68, 70, 72, 74, 76, and 78 may each include sub-elements that influence the health of the respective status indicator 62, 66, 68, 70, 72, 74, 76, and 78. Accordingly, each of the status indicators 62, 66, 68, 70, 72, 74, 76, and 78 is selectable to display portions of the tree of the GUI 58 below the respective status indicator 62, 66, 68, 70, 72, 74, 76, and 78 and selectable to hide the portions of the tree of the GUI 58 below the respective status indicator 62, 66, 68, 70, 72, 74, 76, and 78. When the status of the status indicators 80, 82, 84, 86, 88, 90, 92, and 94 change (e.g., due to non-compliance of a barrier element associated therewith, either tied to operational or non-operational inputs), the status of other status icons 62, 66, 68, 70, 72, 74, 76, and 78 in the GUI 58 also change to reflect the compromised status of the well control barrier and, thus, the barrier management system as a whole. Likewise, when the status of one or more of the status indicators 62, 66, 68, 70, 72, 74, 76, 78, 80, 82, 84, 86, 88, 90, 92, and 94 is altered, a user can view a solution or a list of solutions ordered, for example, in a most to least likely chance of fixing the underlying issue causing the change in status of the status indicators 62, 66, 68, 70, 72, 74, 76, 78, 80, 82, 84, 86, 88, 90, 92, and 94. For example, a user can roll a mouse icon over one of the status indicators 62, 66, 68, 70, 72, 74, 76, 78, 80, 82, 84, 86, 88, 90, 92, and 94 and leave the mouse icon over the status indicators 62, 66, 68, 70, 72, 74, 76, 78, 80, 82, 84, 86, 88, 90, 92, and 94 for a period of time, causing a list to be displayed in the GUI 58. Alternatively, a location of the status indicators 62, 66, 68, 70, 72, 74, 76, 78, 80, 82, 84, 86, 88, 90, 92, and 94 may be selected by a user to generate the list of potential solutions.

In some embodiments, indicators of the status indicators 62, 66, 68, 70, 72, 74, 76, 78, 80, 82, 84, 86, 88, 90, 92, and 94 may correspond to particular timing requirements for the performance of particular duties. In one embodiment, one indicator (e.g., a first color, such as grey) may represent that insufficient data points are available to indicate full health (e.g., typically indicated via another indicator, such as a second color as green). Likewise, an additional indicator (e.g., a third color, such as yellow) may indicate that an issue (e.g., failure of the crew to pass a test, upcoming maintenance, the nearing of an end of life of a part or device, a device approaching or meeting a threshold operating value, or the like) that is affecting the health of the barrier management system does not need to be urgently attended to, but should be addressed within a particular period of time. An indicator (e.g., a fourth color, such as orange), may indicate that an issue (e.g., failure of the crew to pass a test, upcoming maintenance, the nearing of an end of life of a part or device, a device approaching or meeting a threshold operating value, or the like) that is affecting the health of the barrier management system should be attended to within a shortened particular period of time. Likewise, an indicator (e.g., a fifth color, such as red) may indicate that an issue (e.g., failure of the crew to pass a test, upcoming maintenance, the nearing of an end of life of a part or device, a device approaching or meeting a threshold operating value, or the like) that is affecting the health of the barrier management system and needs to be urgently attended to or that another failure requiring immediate attention is present.

In some embodiments, weighting values can be assigned to the various processes, devices, components, or the like that correspond to the status indicators 66, 68, 70, 72, 74, 76, 78, 80, 82, 84, 86, 88, 90, 92, and 94. These weighting values may cause one or more of, for example, the barrier element associated with status indicator 80 to trigger a change in the health status of the status icon 74 more rapidly than the barrier element associated with the status indicator 82. Additionally and/or alternatively, the weighting values may cause one or more of, for example, the barrier element associated with status indicator 80 to trigger a more severe change in the health status of the status indicator 74 (e.g., green to orange or green to red) relative to the barrier element associated with the status indicator 82 (e.g., which would only change the health of the status indicator 74 from green to yellow based upon a given input). Moreover, the weighting values may be separately tied to operational and non-operational inputs for a given barrier element. For example, a respective technical barrier element, an operating barrier element, and an organizational barrier element (each corresponding to a portion of the status indicators 80, 82, 84, 86, 88, 90, 92, and 94) may be weighted to cause a health indication switch more or less rapidly with respect to one another. In some embodiments, the respective technical barrier element and operating barrier element (i.e., operating inputs) may be weighted more heavily with respect to the organizational barrier element (i.e., a non-operational element) or vice versa. Likewise the respective technical barrier element and operating barrier element (i.e., the operating inputs) may be weighted more heavily with respect to one another.

The respective settings (health settings, weighting values, etc.) of a barrier management system may be preset to a default level. This default level may be adjusted to user specified adjusted values for the barrier management system, which may be reflected in the GUI 58 and its operation. Likewise, pre-set values for the for the barrier management system, which may be reflected in the GUI 58 and its operation, can be stored in the computing system 46 for selection. These pre-set values may correspond to different jurisdictions in which the offshore vessel 10 will operate. Thus, as the offshore vessel moves from one location to another, the GUI 58 may be adjusted to correctly correspond to the respective jurisdictions associated with the locations.

In populating the GUI 58, the computing system 46 the system can receive data or other inputs from other programs in operation on the offshore vessel 10. The computing system 46 can manipulate the data under a pre-determined set of rules and thresholds to give a status of, for example, each status indicator 80, 82, 84, 86, 88, 90, 92, and 94 individually. The barrier management system executed by the computing system 46 also can receive or access and utilize historical data, such as incident investigation to further assess the impact of barrier failure and therefore the importance of (as well as an amount of) weighting of barrier health. The individual barrier status corresponds to a set of thresholds and rules that provide an input to the sub-barriers corresponding to status indicators 74, 76, and 78, as well as the status indicators 66, 68, 70, and 72 and ultimately the top status indicator 62 that corresponds to icon 60.

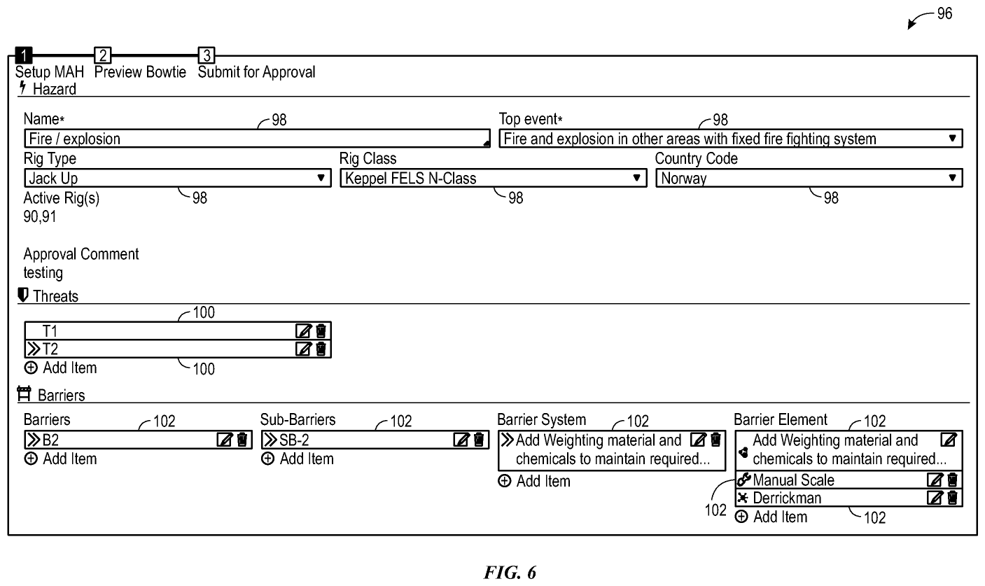

The computing system 46 may receive a configured barrier management system as operating software (i.e., the barrier management system may be loaded or otherwise stored onto the computing system 46). Alternatively, the barrier management system, as represented by the GUI 58, may be generated on the offshore platform 10. Regardless of where the barrier management system is generated (e.g., on or off of the offshore platform 10), FIG. 6 illustrates a screen shot of an example of a composition page 96 (as a portion of a barrier management system tool or a similar program) that includes one or more editable fields 98 with respect to hazards and/or types of offshore platforms 10, one or more editable fields 100 that correspond to potential threats (e.g., events), and one or more editable fields 102 that correspond to respective barriers, sub-barriers, and barrier elements. Taken in combination, by editing the editable fields 98, 100, and 102, the GUI 58 may be configured or otherwise setup.

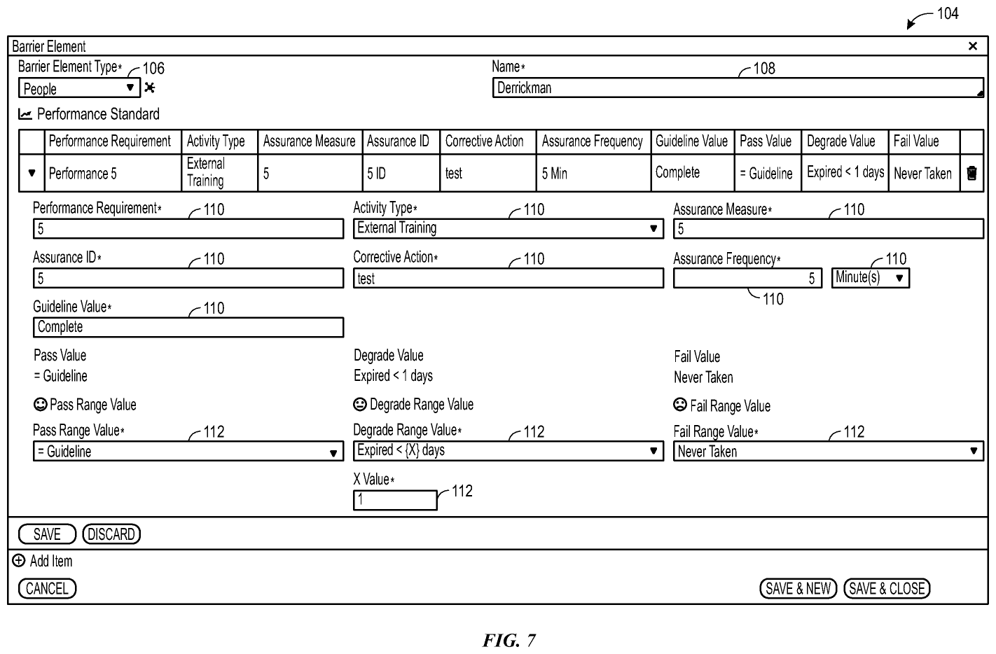

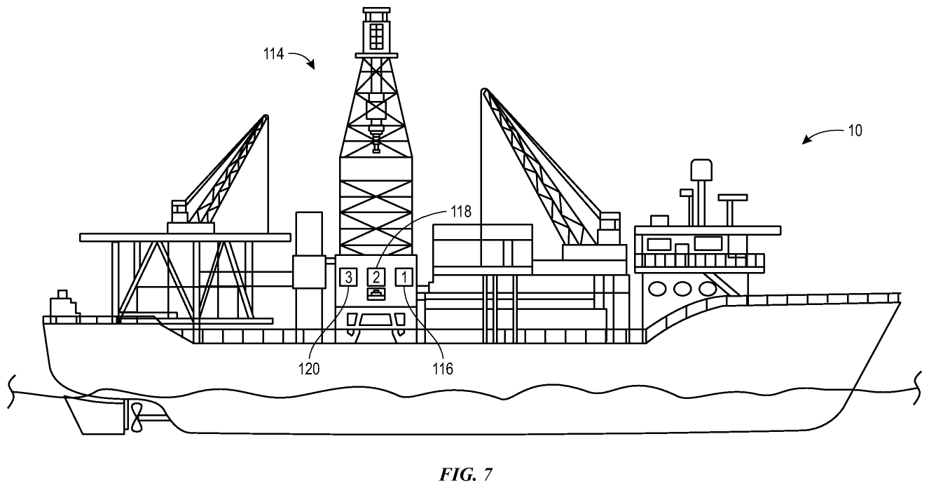

FIG. 7 illustrates a screen shot of an example of a sub-screen 104 of the composition page 96. More particularly, the sub-screen corresponds to the editable field 102 of barrier element 34 with respect to the organizational barrier element 44. As illustrated, the sub-screen 104 includes a barrier type editable field 106, a name field 108, performance value fields 110, as well as compliance fields 112. A user may be able to edit the fields 106, 108, 110 and save the changes (or discard entered values) as an update to the editable field 102 of barrier element 34 with respect to the organizational barrier element 44. In this manner, the composition page 96 may have granular levels of detail that allow for a more robust GUI 58.

FIG. 8 illustrates a screen shot of an image 114 of an offshore platform in conjunction with present embodiments. In addition to, in place of, or as part of the GUI 58, the image 114 may be displayed on the display 54. The image 114 may include status indicators 116, 118, and 120 that are positioned at locations in direct relation to the equipment or work that is being monitored or controlled. Each of the status indicators 116, 118, and 120 may be selectable and may reveal, for example, solutions to issues indicated by the status indicators 116, 118, and 120. Additionally and/or alternatively, the status indicators 116, 118, and 120 may be selectable to reveal a GUI 58, such as a tree of elements, as discussed previously in conjunction with FIG. 5. The status indicator may also reveal operational or non-operational information for the selected barrier elements based on information entered on 104, for example performance requirements or performance value fields such as 110. Through the use of a single image, a high level presentation of the barrier management system may be displayed for ease of understanding by a user as well as for decision making and rapid response to one of multiple barriers being monitored and managed.

This written description uses examples to disclose the above description to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Accordingly, while the above disclosed embodiments may be susceptible to various modifications and alternative forms, specific embodiments have been shown by way of example in the drawings and have been described in detail herein. However, it should be understood that the embodiments are not intended to be limited to the particular forms disclosed. Rather, the disclosed embodiment are to cover all modifications, equivalents, and alternatives falling within the spirit and scope of the embodiments as defined by the following appended claims.

What is claimed is:

1. A system, comprising:
a computing system, comprising:
an interface configured to receive a first signal indicative of operational data of a device engaged in a hydrocarbon operation;
a memory configured to store a value corresponding to non-operational data related to a crewmember interaction with the device; and
a processor configured to generate a graphical user interface, wherein the graphical user interface comprises a status identifier generated based upon the first signal and the value.

2. The system of claim 1, wherein the first signal indicative of the operational data is indicative of a physical status of the device separate from operation of the device.

3. The system of claim 1, wherein the first signal indicative of the operational data is indicative of an operating characteristic of the device.

4. The system of claim 3, wherein the interface is configured to receive a second signal indicative of the operational data of the device.

5. The system of claim 4, wherein the second signal indicative of the operational data is indicative of a physical status of the device separate from operation of the device.

6. The system of claim 5, wherein the status identifier is additionally generated based upon the second signal.

7. The system of claim 4, comprising a first sensor configured to measure a sensed value indicative of a physical status of the device separate from operation of the device and to generate the second signal based on the sensed value.

8. The system of claim 7, comprising a second sensor configured to measure a second sensed value indicative of the operating characteristic of the device and to generate the first signal based on the second sensed value.

9. The system of claim 1, wherein the processor is configured to generate a weighting value and apply the weighting value to adjust an impact the first signal has on the status identifier relative to a second impact the value has on the status identifier.

10. A tangible non-transitory computer-readable medium having computer executable code stored thereon, the code comprising instructions to cause a processor to:
receive a first signal indicative of operational data of a device engaged in a hydrocarbon operation;
receive a value corresponding to non-operational data related to a crewmember interaction with the device; and
generate a graphical user interface to be displayed on a display, wherein the graphical user interface comprises a status identifier generated based upon the first signal and the value.

11. The tangible non-transitory computer-readable medium of claim 10, wherein the code comprises instructions to cause the processor to interpret the first signal as indicative of a physical status of the device separate from operation of the device.

12. The tangible non-transitory computer-readable medium of claim 10, wherein the code comprises instructions to cause the processor to interpret the first signal as indicative of an operating characteristic of the device.

13. The tangible non-transitory computer-readable medium of claim 12, wherein the code comprises instructions to cause the processor to receive a second signal indicative of the operational data of the device.

14. The tangible non-transitory computer-readable medium of claim 13, wherein the code comprises instructions to cause the processor to receive the second signal as indicative of a physical status of the device separate from operation of the device.

15. The tangible non-transitory computer-readable medium of claim 14, wherein the code comprises instructions to cause the processor to additionally generate the status identifier based upon the second signal.

16. The tangible non-transitory computer-readable medium of claim 10, wherein the code comprises instructions to cause the processor to generate a weighting value and apply the weighting value to adjust an impact the first signal has on the status identifier relative to a second impact the value has on the status identifier.

17. A method, comprising:
receiving a first signal indicative of operational data of a device engaged in a hydrocarbon operation;
receiving a value corresponding to non-operational data related to a crewmember interaction with the device; and
generating a graphical user interface to be displayed on a display, wherein the graphical user interface comprises a status identifier generated based upon the first signal and the value.

18. The method of claim 17, comprising:
interpreting the first signal as indicative of an operating characteristic of the device; and
receiving a second signal indicative of the operational data of the device, wherein the second signal indicative of the operational data is indicative of a physical status of the device separate from operation of the device.

19. The method of claim 18, comprising additionally generating the status identifier based upon the second signal.

20. The method of claim 17, comprising generating a weighting value and applying the weighting value to adjust an impact the first signal has on the status identifier relative to a second impact the value has on the status identifier.
